(19) United States
(12) Patent Application Publication
(10) Pub. No.: US 2025/0247849 A1
(43) Pub. Date: Jul. 31, 2025

(54) UPLINK SINGLE FREQUENCY NETWORK OPERATION IN UNIFIED TRANSMISSION CONFIGURATION INDICATION FRAMEWORK

(71) Applicant: QUALCOMM INCORPORATED, San Diego, CA (US)

(72) Inventors: Fang Yuan, Beijing (CN); Yan Zhou, San Diego, CA (US); Tao Luo, San Diego, CA (US)

(21) Appl. No.: 18/855,901

(22) PCT Filed: May 18, 2022
(86) PCT No.: PCT/CN2022/093528

§ 371 Date: Oct. 10, 2024

(51) Int. Cl. H04W 72/21; H04W 72/0453

(52) U.S. Cl. CPC H04W 72/21; H04W 72/0453

(57) ABSTRACT

Methods, systems, and devices for wireless communications are described. A user equipment (UE) may receive control signaling enabling uplink communications with a network via a first transmission and reception point (TRP) using a first set of antenna elements of the UE and via a second TRP using a second set of antenna elements of the UE during a same set of time and frequency resources according to a single frequency network (SFN) configuration. The control signaling may include a set of parameters enabling the uplink communications with the network via a physical uplink control channel (PUCCH) or a physical uplink shared channel (PUSCH). The control signaling may also include a control resource set including an indication for the UE to transmit according to a SFN transmission scheme. The UE may transmit according to the SFN configuration, the uplink communications to the network via the first TRP and the second TRP.

### CROSS REFERENCE

The present application is a 371 national stage filing of International PCT Application No. PCT/CN2022/093528 by Yuan et al. entitled “UPLINK SINGLE FREQUENCY NETWORK OPERATION IN UNIFIED TRANSMISSION CONFIGURATION INDICATION FRAMEWORK,” filed May 18, 2022; and claims priority to International Patent.

### FIELD OF TECHNOLOGY

The present disclosure relates to wireless communications, including uplink single frequency network (SFN) operation in unified transmission configuration indication (TCI) framework.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support uplink single frequency network (SFN) operation in unified transmission configuration indication (TCI) framework. For example, the described techniques provide for the utilization of one or more parameters at a user equipment (UE) that may allow the UE to perform uplink SFN operations that support a unified TCI framework. For example, the UE may receive control signaling that configures SFN based transmission for one or more uplink channel types (e.g., physical uplink control channel (PUCCH), physical uplink shared channel (PUSCH), or a combination thereof). In some examples, the UE may perform SFN transmissions for PUSCH using precoders associated with one or more sounding reference signal (SRS) resource sets. In some cases, the UE may determine to enable SFN operation for at least one uplink channel based on a control resource set (CORESET) associated with the RRC signaling including a flag indicating the use of unified TCI. In examples where SFN operation may be enabled for at least one uplink channel, the UE may receive an indication of a TCI codepoint associated with two or more respective uplink TCI states to use for transmission to respective transmission and reception points (TRPs). If the UE is enabled with SFN operation, the UE may dynamically switch between non-SFN transmission scheme and an SFN transmission scheme.

A method for wireless communications at a UE is described. The method may include receiving control signaling enabling uplink communications with a network via a first TRP using a first set of antenna elements of the UE and via a second TRP using a second set of antenna elements of the UE during a same set of time and frequency resources according to a SFN configuration and transmitting, according to the SFN configuration, the uplink communications to the network via the first TRP and the second TRP.

An apparatus for wireless communications at a UE is described. The apparatus may include a processor, memory coupled with the processor, and instructions stored in the memory. The instructions may be executable by the processor to cause the apparatus to receive control signaling enabling uplink communications with a network via a first TRP using a first set of antenna elements of the UE and via a second TRP using a second set of antenna elements of the UE during a same set of time and frequency resources according to a SFN configuration and transmit, according to the SFN configuration, the uplink communications to the network via the first TRP and the second TRP.

Another apparatus for wireless communications at a UE is described. The apparatus may include means for receiving control signaling enabling uplink communications with a network via a first TRP using a first set of antenna elements of the UE and via a second TRP using a second set of antenna elements of the UE during a same set of time and frequency resources according to a SFN configuration and means for transmitting, according to the SFN configuration, the uplink communications to the network via the first TRP and the second TRP.

A non-transitory computer-readable medium storing code for wireless communications at a UE is described. The code may include instructions executable by a processor to receive control signaling enabling uplink communications with a network via a first TRP using a first set of antenna elements of the UE and via a second TRP using a second set of antenna elements of the UE during a same set of time and frequency resources according to a SFN configuration and transmit, according to the SFN configuration, the uplink communications to the network via the first TRP and the second TRP.

In some examples of the method, apparatuses, and non-transitory computer-readable medium described herein, receiving the control signaling may include operations, features, means, or instructions for receiving a set of parameters enabling the uplink communications with the network via a PUCCH or a PUSCH and transmitting, the uplink communications to the network via the PUCCH or the PUSCH in accordance with the set of parameters.

Some examples of the method, apparatuses, and non-transitory computer-readable medium described herein may further include operations, features, means, or instructions for selecting one or more SRS sets based on receiving the control signaling enabling the uplink communications with the network according to the SFN configuration.

In some examples of the method, apparatuses, and non-transitory computer-readable medium described herein, selecting the one or more SRS sets may include operations, features, means, or instructions for selecting a first SRS set and a second SRS set configured at the UE and receiving downlink control information (DCI) or a configured grant (CG) including a first resource indicator associated with the first SRS set and a second resource indicator associated with the second SRS set: where the first resource indicator and the second resource indicator may be SRS resource indicators (SRIs), transmit precoding matrix indices (TPMIs), or a combination thereof.

In some examples of the method, apparatuses, and non-transitory computer-readable medium described herein, the first resource indicator and the second resource indicator may have a same indicator rank and share a same set of demodulated reference signal (DMRS) ports.

In some examples of the method, apparatuses, and non-transitory computer-readable medium described herein, selecting the one or more SRS sets may include operations, features, means, or instructions for receiving a first reference signal indicating a first SRS set and a second reference signal indicating a second SRS set and receiving DCI or a CG including a first resource indicator associated with the first SRS set and a second resource indicator associated with the second SRS set: where the first resource indicator and the second resource indicator may be SRIs.

In some examples of the method, apparatuses, and non-transitory computer-readable medium described herein, the first resource indicator and the second resource indicator may have a same indicator rank and share a same set of DMRS ports.

In some examples of the method, apparatuses, and non-transitory computer-readable medium described herein, receiving the control signaling may include operations, features, means, or instructions for receiving a CORESET associated with the control signaling, the CORESET including an indication for the UE to transmit the uplink communications to the network according to a SFN transmission scheme.

In some examples of the method, apparatuses, and non-transitory computer-readable medium described herein, receiving the control signaling may include operations, features, means, or instructions for receiving a CORESET associated with the control signaling, the CORESET including an indication for the UE to transmit the uplink communications to the network according to a transmission scheme different from a SFN transmission scheme.

Some examples of the method, apparatuses, and non-transitory computer-readable medium described herein may further include operations, features, means, or instructions for receiving one or more messages indicating a first TCI codepoint including one or more TCIs based on receiving the control signaling enabling the uplink communications with the network.

In some examples of the method, apparatuses, and non-transitory computer-readable medium described herein, receiving the one or more messages may include operations, features, means, or instructions for receiving a medium access control-control element (MAC-CE) activating a set of multiple TCI codepoints configured at the UE and receiving DCI including a TCI that indicates the first TCI codepoint from the set of multiple activated TCI codepoints.

In some examples of the method, apparatuses, and non-transitory computer-readable medium described herein, receiving the one or more messages may include operations, features, means, or instructions for receiving a MAC-CE activating a single TCI codepoint of a set of multiple TCI codepoints configured at the UE.

In some examples of the method, apparatuses, and non-transitory computer-readable medium described herein, the first TCI codepoint includes one TCI and the method, apparatuses, and non-transitory computer-readable medium may include further operations, features, means, or instructions for transmitting, according to the SFN configuration, the uplink communications to the network via the first TRP, where the SFN configuration may be a non-SFN transmission scheme.

In some examples of the method, apparatuses, and non-transitory computer-readable medium described herein, the first TCI codepoint includes two or more TCIs and the method, apparatuses, and non-transitory computer-readable medium may include further operations, features, means, or instructions for transmitting, according to the SFN configuration, the uplink communications to the network via the first TRP and the second TRP, where the SFN configuration may be a SFN transmission scheme.

In some examples of the method, apparatuses, and non-transitory computer-readable medium described herein, the first TCI codepoint includes two or more TCIs and the method, apparatuses, and non-transitory computer-readable medium may include further operations, features, means, or instructions for receiving DCI including a TRP switching indication indicating to use a first TCI associated with the first TRP and transmitting, according to the SFN configuration, the uplink communications to the network via the first TRP, where the SFN configuration includes a non-SFN transmission scheme.

In some examples of the method, apparatuses, and non-transitory computer-readable medium described herein, the first TCI codepoint includes two or more TCIs and the method, apparatuses, and non-transitory computer-readable medium may include further operations, features, means, or instructions for receiving DCI including a TRP switching indication indicating to use the two or more TCIs and transmitting, according to the SFN configuration, the uplink communications to the network via the first TRP and the second TRP, where the SFN configuration includes a SFN transmission scheme.

A method for wireless communications at a network entity is described. The method may include transmitting, control signaling enabling a UE to perform uplink communications with a network via a first TRP using a first set of antenna elements of the UE and via a second TRP using a second set of antenna elements of the UE during a same set of time and frequency resources according to a SFN configuration and receiving, according to the SFN configuration, the uplink communications to the network via the first TRP, the second TRP, or a combination thereof.

An apparatus for wireless communications at a network entity is described. The apparatus may include a processor, memory coupled with the processor, and instructions stored in the memory. The instructions may be executable by the processor to cause the apparatus to transmit, control signaling enabling a UE to perform uplink communications with a network via a first TRP using a first set of antenna elements of the UE and via a second TRP using a second set of antenna elements of the UE during a same set of time and frequency resources according to a SFN configuration and receive, according to the SFN configuration, the uplink communications to the network via the first TRP, the second TRP, or a combination thereof.

Another apparatus for wireless communications at a network entity is described. The apparatus may include means for transmitting, control signaling enabling a UE to perform uplink communications with a network via a first TRP using a first set of antenna elements of the UE and via a second TRP using a second set of antenna elements of the UE during a same set of time and frequency resources according to a SFN configuration and means for receiving, according to the SFN configuration, the uplink communications to the network via the first TRP, the second TRP, or a combination thereof.

A non-transitory computer-readable medium storing code for wireless communications at a network entity is described. The code may include instructions executable by a processor to transmit, control signaling enabling a UE to perform uplink communications with a network via a first TRP using a first set of antenna elements of the UE and via a second TRP using a second set of antenna elements of the UE during a same set of time and frequency resources according to a SFN configuration and receive, according to the SFN configuration, the uplink communications to the network via the first TRP, the second TRP, or a combination thereof.

In some examples of the method, apparatuses, and non-transitory computer-readable medium described herein, transmitting the control signaling may include operations, features, means, or instructions for transmitting a set of parameters enabling the uplink communications with the network via a PUCCH or a PUSCH and receiving, the uplink communications via the PUCCH or the PUSCH in accordance with the set of parameters.

In some examples of the method, apparatuses, and non-transitory computer-readable medium described herein, transmitting the control signaling may include operations, features, means, or instructions for transmitting a CORESET associated with control signaling, the CORESET including an indication for the UE to transmit the uplink communications to the network according to a SFN transmission scheme.

In some examples of the method, apparatuses, and non-transitory computer-readable medium described herein, transmitting the control signaling may include operations, features, means, or instructions for transmitting a CORESET associated with the control signaling, the CORESET including an indication for the UE to transmit the uplink communications to the network according to a transmission scheme different from a SFN transmission scheme.

Some examples of the method, apparatuses, and non-transitory computer-readable medium described herein may further include operations, features, means, or instructions for transmitting one or more messages indicating a first TCI codepoint including one or more TCIs based on receiving the control signaling enabling the uplink communications with the network.

### BRIEF DESCRIPTION OF THE DRAWINGS

FIG. 1 illustrates an example of a wireless communications system that supports uplink single frequency network (SFN) operation in unified transmission configuration indication (TCI) framework in accordance with one or more aspects of the present disclosure.

FIG. 2 illustrates an example of a network architecture that supports uplink SFN operation in unified TCI framework in accordance with one or more aspects of the present disclosure.

FIG. 3 illustrates an example of a wireless communications system that supports uplink SFN operation in unified TCI framework in accordance with one or more aspects of the present disclosure.

FIG. 4 illustrates an example of a process flow that supports uplink SFN operation in unified TCI framework in accordance with one or more aspects of the present disclosure.

FIG. 5 illustrates an example of a process flow that supports uplink SFN operation in unified TCI framework in accordance with one or more aspects of the present disclosure.

FIGS. 6 and 7 show block diagrams of devices that support uplink SFN operation in unified TCI framework in accordance with one or more aspects of the present disclosure.

FIG. 8 shows a block diagram of a communications manager that supports uplink SFN operation in unified TCI framework in accordance with one or more aspects of the present disclosure.

FIG. 9 shows a diagram of a system including a device that supports uplink SFN operation in unified TCI framework in accordance with one or more aspects of the present disclosure.

FIGS. 10 and 11 show block diagrams of devices that support uplink SFN operation in unified TCI framework in accordance with one or more aspects of the present disclosure.

FIG. 12 shows a block diagram of a communications manager that supports uplink SFN operation in unified TCI framework in accordance with one or more aspects of the present disclosure.

FIG. 13 shows a diagram of a system including a device that supports uplink SFN operation in unified TCI framework in accordance with one or more aspects of the present disclosure.

FIGS. 14 through 17 show flowcharts illustrating methods that support uplink SFN operation in unified TCI framework in accordance with one or more aspects of the present disclosure.

### DETAILED DESCRIPTION

Some wireless communication systems may support a unified transmission configuration indicator (TCI) framework, where different unified TCI types may be used to improve channel utilization between wireless devices. For example, a wireless communications system may support multiple downlink and uplink TCI states which may facilitate in communications between a user equipment (UE) and multiple transmission and reception points (TRPs) associated with one or more network entities. In some cases, the UE may communicate with TRPs, and each TRP may transmit a same signal to the UE using a different beam (e.g., using the same time and frequency resource, but different spatial resources), which may be referred to as single-frequency network (SFN) communications. As such, the UE may receive downlink SFN communications in accordance with a unified TCI framework. Currently, however, wireless communications systems may not support techniques for applying unified TCI types for uplink SFN communications.

As such, the utilization of one or more parameters at a UE may allow the UE to perform uplink SFN operations that support a unified TCI framework. For example, the UE may receive radio resource control (RRC) signaling that configures SFN based transmission for one or more uplink channel types (e.g., physical uplink control channel (PUCCH), physical uplink shared channel (PUSCH), or a combination thereof). In some examples, the UE may perform SFN transmissions for PUSCH using precoders indications associated with one or more sounding reference signal (SRS) resource sets. In some cases, the UE may determine to enable SFN operation for at least one uplink channel based on a control resource set (CORESET) associated with the RRC signaling including a flag (e.g., a bit, set of bits, signal, sequence, field value, or other indicator) indicating the use of unified TCI (e.g., a followUnifiedTCI flag).

In examples where SFN operation may be enabled for at least one uplink channel, the UE may receive an indication of a TCI codepoint associated with two or more respective uplink TCI states to use for transmission to respective TRPs. In some cases, the TCI codepoint may be indicated via downlink control information (DCI), a medium access control-control element (MAC-CE), or other control signaling, that indicates one TCI codepoint from a set of TCI codepoints.

If the UE is enabled with SFN operation, the UE may switch (e.g., dynamically switch) between non-SFN transmission scheme and an SFN transmission scheme for uplink communications. A non-SFN transmission scheme may be any transmission scheme (a second transmission scheme) used by the UE for uplink other than the same SFN transmission scheme, for example a single TRP transmission scheme, multiple TRP transmission scheme (e.g., using single DCI scheduling, multiple DCI scheduling, DCI repetition), or PUCCH and/or PUSCH repetition, or other transmission scheme described herein. For example, if the received TCI codepoint is associated with a single uplink viable TCI state, the UE may operate in accordance with the non-SFN transmission scheme and if the received TCI codepoint is associated with a two or more uplink viable TCI states, the UE may operate in accordance with the SFN transmission scheme. Additionally, or alternatively, the UE may receive a DCI that includes a dedicated TRP switching indication field in cases where the UE receives a TCI codepoint associated with two TCI states. As such, the TRP switching indication may indicate for the UE to use the first TCI state (e.g., for the non-SFN transmission scheme), use the second TCI state (e.g., for the non-SFN transmission scheme), or use both the first and second TCI states (e.g., for SFN transmissions).

Aspects of the disclosure are initially described in the context of wireless communications systems. Aspects of the disclosure are further illustrated by and described with reference to network architecture and process flows. Aspects of the disclosure are further illustrated by and described with reference to apparatus diagrams, system diagrams, and flowcharts that relate to uplink SFN operation in unified TCI framework.

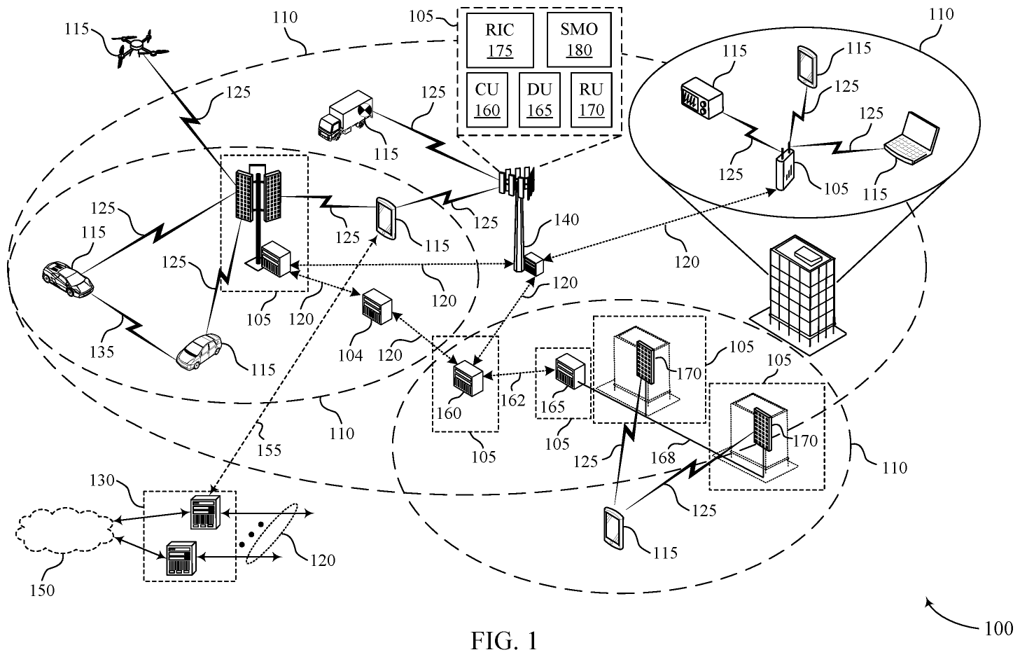

FIG. 1 illustrates an example of a wireless communications system 100 that supports uplink SFN operation in unified TCI framework in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink SFN operation in unified TCI framework as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

In the wireless communication system 100, a UE 115 may communicate with the network via two or more TRPs. The wireless communications system 100 may apply a unified TCI state framework. In some cases, three types of unified TCI states may be defined. A first type of TCI state (e.g., type 1) may include a joint TCI state to indicate a common beam for at least one downlink channel or reference signal and at least one uplink channel or reference signal (e.g., including UE-specific physical downlink control channel (PDCCH), UE-specific physical downlink shared channel (PDSCH), UE-specific PUCCH, and UE-specific PUSCH). A second type of TCI state (e.g., type 2) may include a downlink TCI state to indicate a common beam for more than one downlink channel or reference signal (e.g., including at least UE-specific PDCCH and UE-specific PDSCH). A third type of TCI state (e.g., type 3) may include an uplink TCI state to indicate a common beam for more than one uplink channel or reference signal (e.g., including at least UE-specific PUCCH and UE-specific PUSCH). For example, the network may indicate to the UE 115 multiple downlink or uplink states for multiple TRPs. In some examples, an uplink applicable TCI can be either joint TCI or uplink TCI.

In some cases, the UE 115 may be configured to transmit uplink communications via an SFN configuration. In an SFN configuration, a UE 115 may transmit a same uplink signal in a same time and frequency resources to two or more TRPs using different beams via different antenna panels at the UE 115. Example applications for an uplink SFN configuration may include customer premises equipment, fixed wireless broadband, or industrial devices. In some cases, to facilitate simultaneous multi-panel uplink transmission for higher uplink throughput and reliability (e.g., focusing on FR2 and multi-TRP), uplink precoding indication for PUSCH may be specified, where no new codebook is introduced for multi-panel simultaneous transmission. In some cases, a total number of layers may be up to four across all panels and a total number of codewords may be up to two across all panels, considering single DCI and multi-DCI based multi-TRP operation. In some cases, to facilitate simultaneous multi-panel uplink transmission for higher uplink throughput and reliability (e.g., focusing on FR2 and multi-TRP), uplink beam indication for PUCCH or PUSCH may be specified, where a unified TCI framework may be assumed considering single DCI and multi-DCI based multi-TRP operation. For the case of multi-DCI based multi-TRP operation, in some examples PUSCH+PUSCH or PUCCH+PUCCH may be transmitted across two panels in a same component carrier. In some cases, timing advances for uplink multi-DCI for multi-TRP operation may be specified. In some cases, power control for uplink single DCI for multi-TRP operation may be applied.

As such, the utilization of one or more parameters at a UE 115 may allow the UE 115 to perform uplink SFN operations that support a unified TCI framework. For example, the UE 115 may RRC signaling that configures SFN based transmission for one or more uplink channel types. In some examples, the UE 115 may perform SFN transmissions for PUSCH using precoders indications associated with one or more SRS resource sets received from a network entity 105. In some cases, the UE 115 may determine to enable SFN operation for at least one uplink channel based on a CORESET associated with the RRC signaling including a flag indicating the use of unified TCI.

In examples where SFN operation may be enabled for at least one uplink channel, the UE 115 may receive an indication of a TCI codepoint associated with two or more respective uplink applicable TCI states to use for transmission to respective TRPs. In some cases, the TCI codepoint may be indicated via DCI, MAC-CE, other control signaling, or a combination thereof that indicates one TCI codepoint from a set of TCI codepoints.

If the UE 115 is enabled with SFN operation, the UE 115 may dynamically switch between non-SFN transmission scheme and an SFN transmission scheme. For example, if the received TCI codepoint is associated with a single uplink applicable TCI state, the UE 115 may operate in accordance with the non-SFN transmission scheme and if the received TCI codepoint is associated with a two or more uplink applicable TCI states, the UE 115 may operate in accordance with the SFN transmission scheme. Additionally, or alternatively, the UE 115 may receive a DCI that includes a dedicated TRP switching indication field in cases where the UE 115 receives a TCI codepoint associated with two uplink applicable TCI states. As such, the TRP switching indication may indicate for the UE 115 to use the first TCI state (e.g., for the non-SFN transmission scheme), use the second TCI state (e.g., for the non-SFN transmission scheme), or use both the first and second TCI states (e.g., for SFN transmissions).

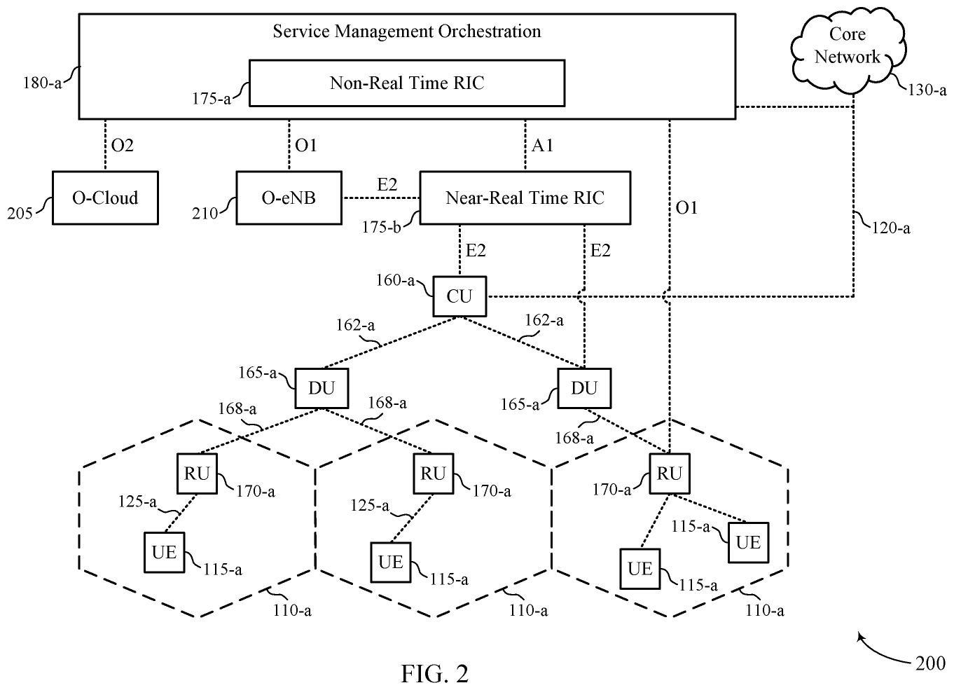

FIG. 2 illustrates an example of a network architecture 200 (e.g., a disaggregated base station architecture, a disaggregated RAN architecture) that supports uplink SFN operation in unified TCI framework in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

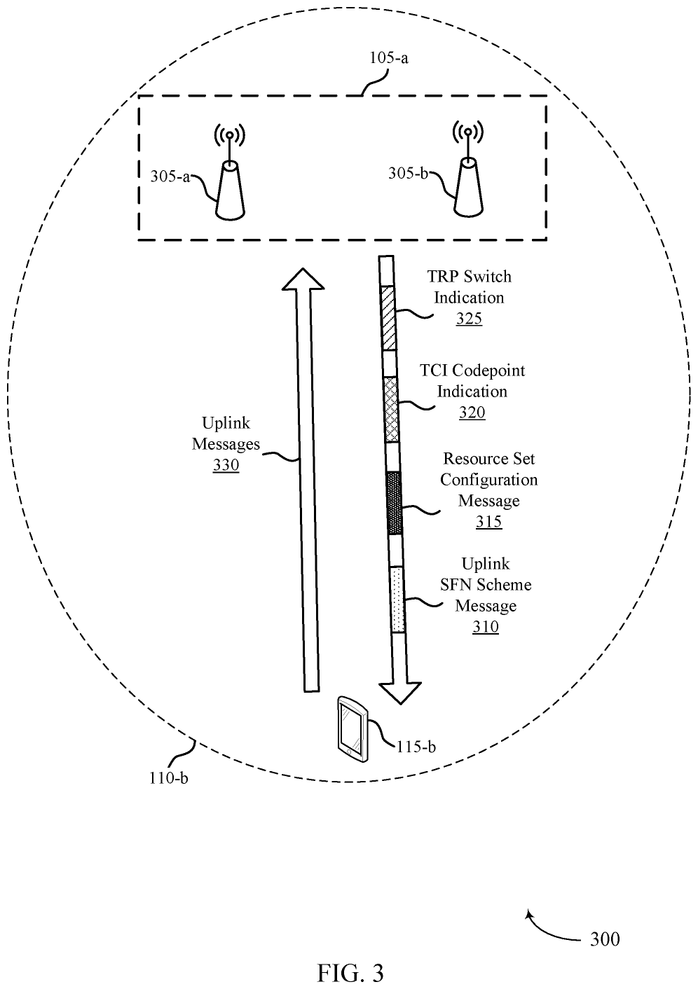

FIG. 3 illustrates an example of a wireless communications system 300 that supports uplink SFN operation in unified TCI framework in accordance with one or more aspects of the present disclosure. In some examples, wireless communications system 300 may implement one or more aspects of wireless communications system 100. For instance, a UE 115-b, a network entity 105-a, and a geographic coverage are 110-b may be respective examples of a UE 115, a network entity 105, and a geographic coverage area 110 as described with reference to FIG. 1. While examples are discussed herein, any number of devices and device types may be used to accomplish implementations described in the present disclosure. Wireless communications system 300 may support uplink SFN operations at the UE 115-b via one or more uplink channels in accordance with a unified TCI framework.

In some examples of wireless communications system 300, the UE 115-b may communicate with one or more TRPs 305 (e.g., a TRP 305-a and a TRP 305-b) associated with one or more network entities 105. While FIG. 3 illustrates TRP 305-a and TRP 305-b as being associated with the network entity 105-a, it is understood that the UE 115-b may communicate with multiple TRPs 305 associated with one or more network entities 105. That is, the UE 115-b may communicate with respective TRPs 305 associated with separate devices (e.g., different network entities 105).

In a single DCI multi-TRP operation or a multi-DCI multi-TRP operation, the UE 115-b may communicate with the first TRP 305-a and the second TRP 305-b using space division multiplexing, frequency division multiplexing, or time division multiplexing, or a combination thereof. The wireless communication system may support DCI repetition (e.g., across CORESETs associated with the first TRP 305-a and the second TRP 305-b), PUSCH and PUCCH repetition, a downlink SFN configuration, or an uplink SFN configuration. For example, in downlink, the UE 115-b may receive PDSCH or PDCCH messages according to an SFN configuration. For example, the UE 115-b may receive a same downlink signal (e.g., a PDSCH or PDCCH message) from the first TRP 305-a and the second TRP 305-b on different beams using different antenna panels at the UE 115-b. In uplink, the UE 115-b may transmit PUSCH or PUCCH messages according to an SFN configuration. For example, the UE 115-b may transmit a same uplink signal to the first TRP 305-a and the second TRP 305-b on different beams using different antenna panels at the UE 115-b.

In some examples, the wireless communications system 300 support a unified TCI framework, where different unified TCI types may be used to improve channel utilization between wireless devices. For example, a wireless communications system may support multiple downlink and uplink TCI states which may facilitate in communications between the UE 115-b and the TRPs 305 associated with one or more network entities 105. For instance, a first TCI type may be a joint TCI state to indicate a common beam for at least one downlink channel (e.g., PDCCH or PDSCH) or reference signal and at least one uplink channel (e.g., PUCCH or PUSCH) or reference signal. Additionally, or alternatively, a second TCI type may be a separate downlink TCI state to indicate a common beam for one or more downlink channels (e.g., PDCCH or PDSCH) or reference signals. Additionally, or alternatively, a third TCI type may be a separate uplink TCI state to indicate a common beam for one or more uplink channels (e.g., PUCCH or PUSCH) or reference signals. In some examples, an uplink applicable TCI may be either joint TCI or uplink TCI.

According to the techniques described herein, the wireless communications system 300 may enable an SFN scheme for uplink for multi-TRP operation. For example, the network entity 105-a may transmit to the UE 115-b, an uplink SFN scheme message 310 which may configure the UE 115-b with one or more parameters in accordance with uplink SFN operations. For instance, the uplink SFN scheme message 310 may include an RRC parameter (e.g., sfnPUCCH) that enables SFN based PUCCH transmissions. Additionally, or alternatively, the uplink SFN scheme message 310 may include an RRC parameter (e.g., sfnPUSCH) that enables SFN based PUSCH transmissions. In some examples, the network entity 105-a may configure the UE 115-b with either the sfnPUCCH parameter or the sfnPUSCH parameter. In some examples, the uplink SFN scheme message 310 may include a RRC parameter (e.g., sfnUL) that enables both SFN based PUCCH and PUSCH transmissions.

In some examples, where the SFN scheme is enabled at the UE 115-b for a PUSCH transmission, the network entity 105-a may schedule a PUSCH via DCI (e.g., DCI 0_0). In some examples, the SFN scheme may apply to a PUSCH that is scheduled by a DCI of any DCI format (e.g., scheduled by a DCI 0_0, DCI0_1 or DCI 0_2). In some other examples, the SFN scheme may apply to a PUSCH that was not scheduled by DCI 0_0 (e.g., scheduled by a DCI 0_1 or DCI 0_2). In some examples, network entity 105-a may configure the UE 115-b with one or more resource sets associated with the uplink precoder indications in accordance with the uplink SFN scheme. For instance, the UE 115-b may use one or two SRS resource sets with its usage set as “codebook” configured at the UE 115-b, which may enable uplink SFN transmission in accordance with codebook-based MIMO transmissions. In some examples, the UE 115-b may receive the resource set configuration message 315 to configure the one or two SRS resource sets with its usage set as “codebook”. Additionally, or alternatively, the UE 115-b may use one or two SRS resource sets with its usage set as “non-codebook”, which may enable uplink SFN transmission in accordance with non-codebook-based MIMO transmissions. For example, the UE 115-b may receive the resource set configuration message 315 which may include two SRS resource sets with its usage set as “non-codebook”, where a first SRS resource set may be associated with a first channel state information reference signals (CSI-RSs) and a second SRS resource set may be associated with a second CSI-RS. For some other example, the UE 115-b may receive the resource set configuration message 315 which may include a SRS resource set with its usage set as “non-codebook”, where the SRS resource set may be associated with a CSI-RS.

In some cases, each of the SRS resource sets may be associated with a respective precoder indication field. For example, the resource set configuration message 315 may include DCI (e.g., DCI 0_1 or DCI 0_2) or a configured grant (CG) configuration (e.g., for a CG PUSCH) that includes two precoder indication fields. The two precoders may be applied with two uplink applicable TCIs in SFN transmission for a PUSCH. In examples of two SRS resource sets with its usage set as “non-codebook” (e.g., for non-codebook based uplink MIMO transmission), the two precoder indication fields may be examples of two SRS resource indicator (SRI) fields, where each field may indicate a precoder associated with an SRS resource set. In examples of two SRS resource sets with its usage set as “codebook” (e.g., for codebook based uplink MIMO transmissions), the two precoder indication fields may be examples of two SRI fields, two transmit precoding matrix index (TPMI) fields, or a combination thereof, where each field indicates a precoder associated with an SRS resource set. In some aspects, the two precoder indications in a DCI or a CG configurations may have a same number of spatial layer (i.e., the same rank) and share a same set of demodulated reference signal (DMRS) antenna ports indicated in the same DCI or CG configurations. In examples of a single SRS resource set with its usage set as “codebook”, there may be a single precoder indication field of SRI, where the field indicates a precoder associated with the SRS resource set and may be applied with two uplink applicable TCIs in SFN transmission for a PUSCH. In examples of a single SRS resource set with its usage set as “non-codebook”, there may be a single precoder indication field of SRI and/or TPMI, where the field indicates a precoder associated with the SRS resource set and may be applied with two uplink applicable TCIs in SFN transmission for a PUSCH.

In some cases, the UE 115-b may apply an uplink SFN to the at least one uplink channel in accordance with a flag associated with the uplink SFN scheme message 310. For example, as part of the uplink SFN scheme message 310, the UE 115-b may receive an associated scheduling CORESET where the CORESET includes a flag that indicates uplink SFN operation in accordance with unified TCI (e.g., followUnifiedTCI flag). As such, the UE 115-b may apply uplink SFN transmission to the uplink channel when the uplink channel is scheduled by an DCI received in the CORESET, if the flag of the CORESET scheduling the uplink channel indicates to follow unified TCI (e.g., the flag of followUnifiedTCI is configured). For example, if the CORESET0 (CORESET zero) is configured with the followUnifiedTCI flag, when a PUCCH or PUSCH is scheduled by a DCI received in the CORESET0, then the UE 115-b may apply uplink SFN to the PUCCH or PUSCH. Additionally, or alternatively, if the CORESET0 is not configured with the followUnifiedTCI flag, when a PUCCH or PUSCH is scheduled by the CORESET0, then the UE 115-b may not apply uplink SFN to the PUCCH or PUSCH, even if an SFN transmission is enabled to a PUCCH or PUSCH transmission.

In examples where the UE 115-b is enabled with SFN operation for at least one uplink channel, the UE 115-b may receive from the network entity 105-a a TCI codepoint indication 320. For example, the TCI codepoint indication 320 may indicate a TCI codepoint for use at the UE 115-b that is associated with two uplink applicable TCI states (e.g., uplink TCI state or joint TCI state). In some examples, the TCI codepoint indication 320 may include one or more messages. For example, the UE 115-b may receive a TCI activation MAC-CE that activates multiple TCI codepoints configured at the UE 115-b, and receive a DCI that includes a TCI indication field that may select one TCI codepoint from the multiple codepoints activated by the MAC-CE. Additionally, or alternatively, the UE 115-b may receive the TCI activation MAC-CE that activates a single TCI codepoint from multiple TCI codepoints configured at the UE 115-b.

In examples where UE 115-b determines not to apply SFN operations to an uplink channel, the UE 115-b may choose one TCI state from the selected TCI codepoint for use with the uplink channel. For example, a first TCI state of the two TCI states in an indicated TCI codepoint may be chosen for an uplink transmission determined not to use SFN operations. In some aspects, the UE 115-b may determine not to apply SFN operation to an uplink channel when the network entity 105-a did not configure the uplink channel for SFN operation. In some other aspects, the UE 115-b may determine not to apply SFN operation to an uplink channel when the network entity 105-a did configure the uplink channel for SFN operation, but the uplink channel is dynamically indicated to not apply SFN operation, such as scheduled via a fallback DCI (e.g., fallback DCI 0_0) or scheduled as a single TRP operation.

In some examples, the UE 115-b may be enabled to switch between a non-SFN transmission scheme (e.g., for single TRP (sTRP) transmission) and an SFN transmission scheme (e.g., for multi-TRP transmission) based on a capability of the UE 115-b (e.g., dynamicSFN capability). As such, the number of uplink applicable TCI states associated with the selected TCI codepoint may determine if the UE 115-b operates in accordance with the SFN transmission scheme or the non-SFN transmission scheme. For example, if the selected TCI codepoint includes a single uplink applicable TCI state, the UE 115-b may operate in accordance with the non-SFN transmission scheme. If the selected TCI codepoint includes two uplink applicable TCI states, the UE 115-b may operate in accordance with the SFN transmission scheme. In some aspects, if the UE 115-b does not provide a UE capability of “dynamicSFN”, the UE 115-b may be indicated with TCI codepoints of two TCIs for SFN transmission, or the UE 115-b may be indicated with TCI codepoints of single TCIs for Non-SFN transmission.

In some examples, the UE 115-b may receive a TRP switch indication 325 from the network entity 105-a. For example, the TRP switch indication 325 may be a field included in a DCI scheduling the uplink channel, when two uplink applicable TCIs in a TCI codepoint are indicated to the UE 115-b. For example, if the TRP switch indication 325 in a DCI indicates to use the first TCI state in the TCI codepoint, the UE 115-b may operate in accordance with the non-SFN transmission scheme to use the first TCI state to transmit the uplink channel. If the TRP switch indication 325 indicates to use the second TCI state in the TCI codepoint, the UE 115-b may operate in accordance with the non-SFN transmission scheme to use the second TCI state to transmit the uplink channel. If the TRP switch indication 325 indicates to use both the first TCI state and the second TCI state, the UE 115-b may operate in accordance with the SFN transmission scheme to use both TCI states to transmit the uplink channel. In some examples, the TRP switch indication 325 may be included in a scheduling DCI for the uplink channel used (e.g., DCI 0_1 or DCI 0_2 for scheduling PUSCH, DCI 1_1 or DCI 1_2 for scheduling PUCCH).

Based on the network entity 105-a configuring the UE 115-b with an uplink SFN transmission scheme, the UE 115-b may transmit one or more uplink messages 330, to the network entity according to the SFN configuration. For example, the UE 115-b may concurrently transmit a first uplink message 330 to both the TRP 305-a using a first set of antenna elements at the UE 115-b and to the TRP 305-b using a second set of antenna elements at the UE 115-b.

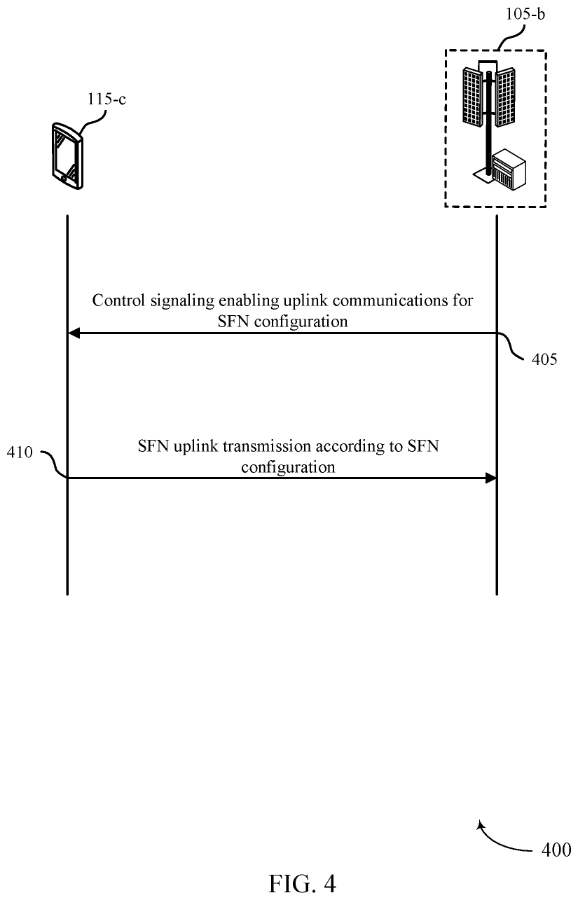

FIG. 4 illustrates an example of a process flow 400 that supports uplink SFN operation in unified TCI framework in accordance with one or more aspects of the present disclosure. In some examples, process flow 400 may implement aspects of wireless communications system 100, network architecture 200, wireless communications system 300, or a combination thereof. Process flow 400 includes a UE 115-c and a network entity 105-b which may be respective examples of a UE 115 and a network entity 105, as described with reference to FIGS. 1 through 3. Alternative examples of the following may be implemented, where some steps are performed in a different order than described or are not performed at all. In some cases, steps may include additional features not mentioned below, or further steps may be added. In addition, while process flow 400 shows processes between a single UE 115 and a single network entity 105, it should be understood that these processes may occur between any number of network devices and network device types.

At 405, the UE 115-c may receive from the network entity 105-b, control signaling enabling uplink communications with a network via a first TRP using a first set of antenna elements of the UE 115-c and via a second TRP using a second set of antenna elements of the UE 115-c during a same set of time and frequency resources according to an SFN configuration. In some examples, the first TRP and the second TRP may be associated with network entity 105-b or may be associated with multiple respective network entities 105.

At 410, the UE 115-c may transmit, according to the SFN configuration, the uplink communications to the network via the first TRP and the second TRP.

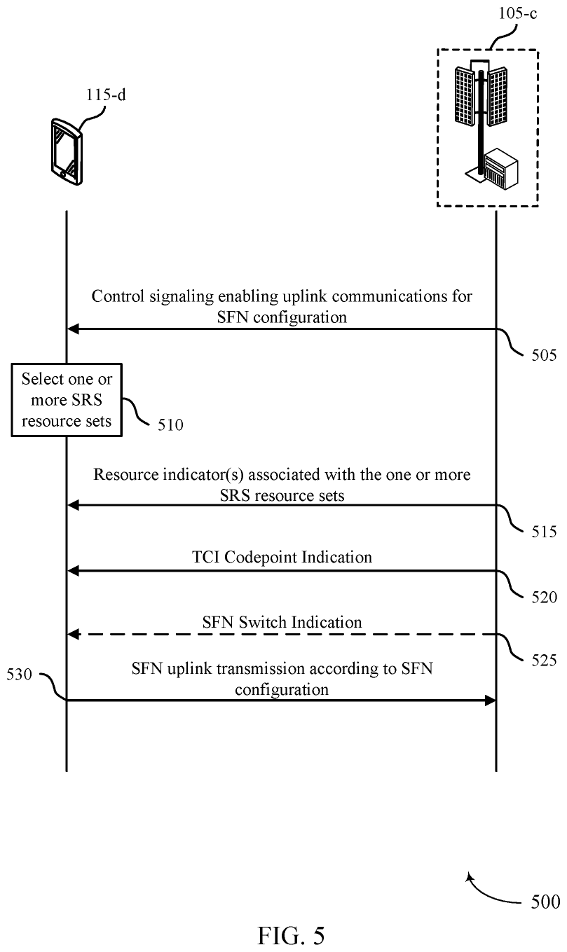

FIG. 5 illustrates an example of a process flow 500 that supports uplink SFN operation in unified TCI framework in accordance with one or more aspects of the present disclosure. In some examples, process flow 500 may implement aspects of wireless communications system 100, network architecture 200, wireless communications system 300, or a combination thereof. Process flow 500 includes a UE 115-d and a network entity 105-c which may be respective examples of a UE 115 and a network entity 105, as described with reference to FIGS. 1 through 3. Alternative examples of the following may be implemented, where some steps are performed in a different order than described or are not performed at all. In some cases, steps may include additional features not mentioned below, or further steps may be added. In addition, while process flow 500 shows processes between a single UE 115 and a single network entity 105, it should be understood that these processes may occur between any number of network devices and network device types.

At 505, the UE 115-d may receive from the network entity 105-c, control signaling enabling uplink communications with a network via a first TRP using a first set of antenna elements of the UE 115-d and via a second TRP using a second set of antenna elements of the UE 115-d during a same set of time and frequency resources according to an SFN configuration. In some examples, the first TRP and the second TRP may be associated with network entity 105-c or may be associated with respective network entities 105. In some examples, the control signaling may include a set of parameters enabling the uplink communications with the network via a PUCCH or a PUSCH. As such, the UE 115-d may transmit the uplink communications to the network via the PUCCH or the PUSCH in accordance with the set of parameters.

In some examples, as part of receiving the control signaling the UE 115-d may also receive a CORESET associated with the control signaling, the control resource set including an indication for the UE 115-d to transmit the uplink communications to the network according to an SFN transmission scheme. Additionally, or alternatively, the CORESET may include an indication for the UE 115-d to transmit the uplink communications to the network according to a transmission scheme different from an SFN transmission scheme.

At 510, the UE 115-d may select one or more SRS resource sets based on receiving the control signaling enabling the uplink communications with the network according to the SFN configuration.

In some examples, the UE 115-d may select a first SRS resource set and a second SRS resource set configured at the UE 115-d. As such, at 515, the UE 115-d may receive DCI or a CG including a first resource indicator associated with the first SRS resource set and a second resource indicator associated with the second SRS resource set, where the first resource indicator and the second resource indicator may be SRIs, TPMIs, or a combination thereof.

In some examples, the UE 115-d may receive a first reference signal (e.g., a first CSI-RS) indicating the first SRS resource set and a second reference signal (e.g., a second CSI-RS) indicating the second SRS resource set. As such, at 515, the UE 115-d may receive DCI or a CG including a first resource indicator associated with the first SRS resource set and a second resource indicator associated with the second SRS resource set, where the first resource indicator and the second resource indicator may be SRIs.

In some examples, the first resource indicator and the second resource indicator may have a same indicator rank and may share a same set of DMRS ports.

At 520, the UE 115-d may receive one or more messages indicating a first TCI codepoint including one or more TCIs based on receiving the control signaling enabling the uplink communications with the network. For example, the UE 115-d may receive a MAC-CE activating a set of TCI codepoints configured at the UE 115-d and receive DCI including a TCI that indicates the first TCI codepoint from the set of activated TCI codepoints. Additionally, or alternatively, the UE 115-d may receive the MAC-CE activating the first TCI codepoint of a set of TCI codepoints configured at the UE 115-d.

At 525, the UE 115-d may receive an SFN switch indication which may indicate for the UE 115-d to switch from a first SFN configuration to a second SFN configuration. For example, if the first TCI codepoint may include two or more TCIs, the UE 115-d may receive a DCI including a TRP switching indication indicating to use a first TCI associated with the first TRP or the second TRP. As such, the UE 115-d may transmit, according to the SFN configuration, the uplink communications to the network via the first TRP or the second TRP, where the SFN configuration may include a non-SFN transmission scheme. Additionally, or alternatively, the UE 115-d may receive DCI including a TRP switching indication indicating to use the two or more TCIs. As such, the UE 115-d may transmit, according to the SFN configuration, the uplink communications to the network via the first TRP and the second TRP, where the SFN configuration may include an SFN transmission scheme.

At 530, the UE 115-d may transmit, according to the SFN configuration, the uplink communications to the network via the first TRP and the second TRP. For example, if the first TCI codepoint includes one TCI valid for uplink transmissions, the UE 115-d may transmit, according to the SFN configuration, the uplink communications to the network via the first TRP, where the SFN configuration is a non-SFN transmission scheme. If the first TCI codepoint includes two or more TCIs valid for uplink transmissions, the UE 115-d may transmit, according to the SFN configuration, the uplink communications to the network via the first TRP and the second TRP, where the SFN configuration is an SFN transmission scheme.

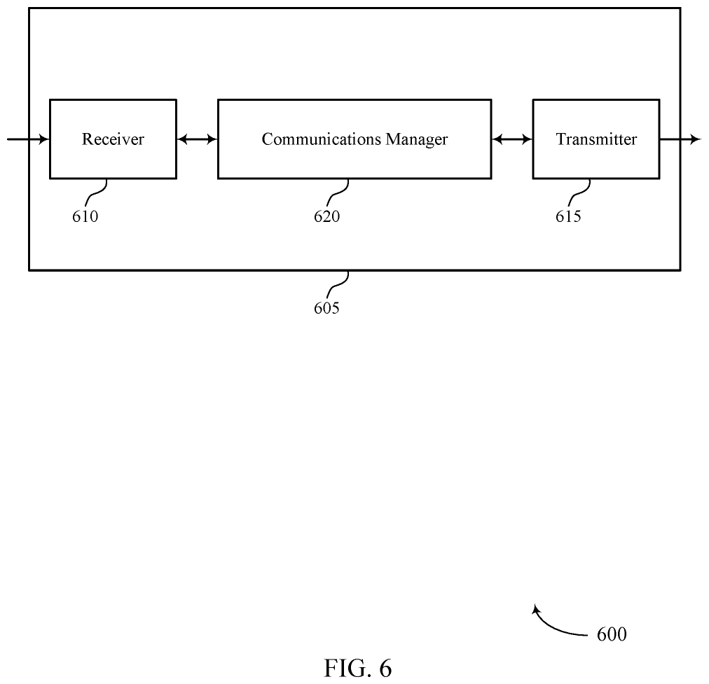

FIG. 6 shows a block diagram 600 of a device 605 that supports uplink SFN operation in unified TCI framework in accordance with one or more aspects of the present disclosure. The device 605 may be an example of aspects of a UE 115 as described herein. The device 605 may include a receiver 610, a transmitter 615, and a communications manager 620. The device 605 may also include a one or more processors, memory coupled with the one or more processors, and instructions stored in the memory that are executable by the one or more processors to enable the one or more processors to perform uplink SFN operation in unified TCI framework discussed herein. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink SFN operation in unified TCI framework). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink SFN operation in unified TCI framework). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of uplink SFN operation in unified TCI framework as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving control signaling enabling uplink communications with a network via a first transmission and reception point using a first set of antenna elements of the UE and via a second transmission and reception point using a second set of antenna elements of the UE during a same set of time and frequency resources according to a SFN configuration. The communications manager 620 may be configured as or otherwise support a means for transmitting, according to the SFN configuration, the uplink communications to the network via the first transmission and reception point and the second transmission and reception point.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources by configuring uplink SFN operation in a TCI framework.

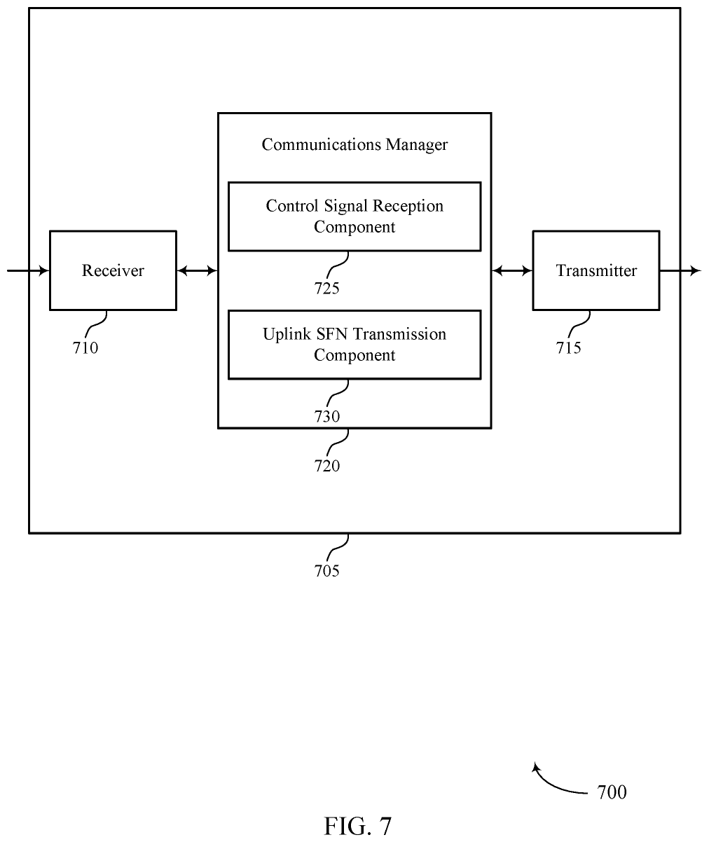

FIG. 7 shows a block diagram 700 of a device 705 that supports uplink SFN operation in unified TCI framework in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to uplink SFN operation in unified TCI framework). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to uplink SFN operation in unified TCI framework). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of uplink SFN operation in unified TCI framework as described herein. For example, the communications manager 720 may include a control signal reception component 725 an uplink SFN transmission component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The control signal reception component 725 may be configured as or otherwise support a means for receiving control signaling enabling uplink communications with a network via a first transmission and reception point using a first set of antenna elements of the UE and via a second transmission and reception point using a second set of antenna elements of the UE during a same set of time and frequency resources according to a SFN configuration. The uplink SFN transmission component 730 may be configured as or otherwise support a means for transmitting, according to the SFN configuration, the uplink communications to the network via the first transmission and reception point and the second transmission and reception point.

In some cases, the control signal reception component 725 and the uplink SFN transmission component 730 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signal reception component 725 and the uplink SFN transmission component 730 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.”

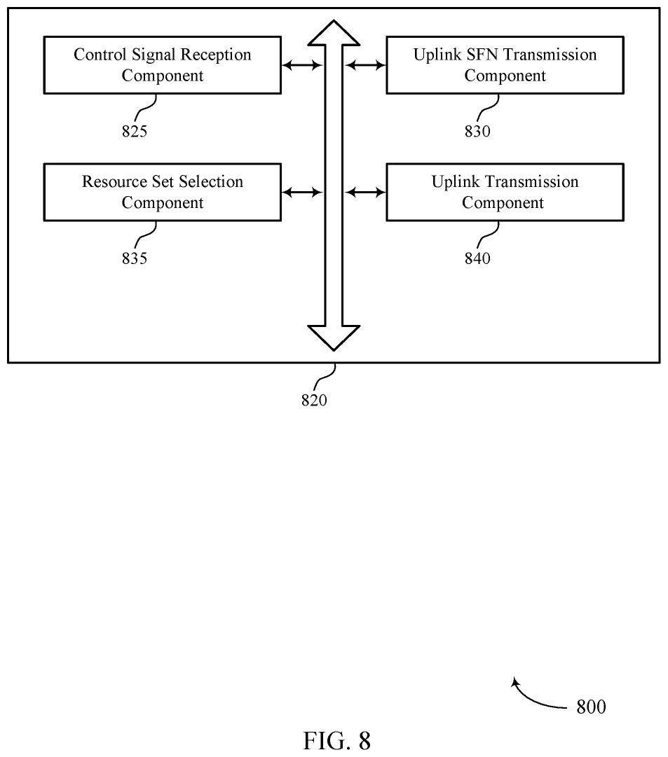

FIG. 8 shows a block diagram 800 of a communications manager 820 that supports uplink SFN operation in unified TCI framework in accordance with one or more aspects of the present disclosure. The communications manager 820 may be an example of aspects of a communications manager 620, a communications manager 720, or both, as described herein. The communications manager 820, or various components thereof, may be an example of means for performing various aspects of uplink SFN operation in unified TCI framework as described herein. For example, the communications manager 820 may include a control signal reception component 825, an uplink SFN transmission component 830, a resource set selection component 835, an uplink transmission component 840, or any combination thereof. Each of these components may communicate, directly or indirectly, with one another (e.g., via one or more buses).

The communications manager 820 may support wireless communications at a UE in accordance with examples as disclosed herein. The control signal reception component 825 may be configured as or otherwise support a means for receiving control signaling enabling uplink communications with a network via a first transmission and reception point using a first set of antenna elements of the UE and via a second transmission and reception point using a second set of antenna elements of the UE during a same set of time and frequency resources according to a SFN configuration. The uplink SFN transmission component 830 may be configured as or otherwise support a means for transmitting, according to the SFN configuration, the uplink communications to the network via the first transmission and reception point and the second transmission and reception point.

In some examples, to support receiving the control signaling, the control signal reception component 825 may be configured as or otherwise support a means for receiving a set of parameters enabling the uplink communications with the network via a physical uplink control channel or a physical uplink shared channel. In some examples, to support receiving the control signaling, the uplink SFN transmission component 830 may be configured as or otherwise support a means for transmitting, the uplink communications to the network via the physical uplink control channel or the physical uplink shared channel in accordance with the set of parameters.

In some examples, the resource set selection component 835 may be configured as or otherwise support a means for selecting one or more sounding reference signal sets based on receiving the control signaling enabling the uplink communications with the network according to the SFN configuration.

In some examples, to support selecting the one or more sounding reference signal sets, the resource set selection component 835 may be configured as or otherwise support a means for selecting a first sounding reference signal set and a second sounding reference signal set configured at the UE. In some examples, to support selecting the one or more sounding reference signal sets, the control signal reception component 825 may be configured as or otherwise support a means for receiving downlink control information or a configured grant including a first resource indicator associated with the first sounding reference signal set and a second resource indicator associated with the second sounding reference signal set: where the first resource indicator and the second resource indicator are sounding reference signal resource indicators, transmit precoding matrix indices, or a combination thereof.

In some examples, the first resource indicator and the second resource indicator have a same indicator rank and share a same set of demodulated reference signal ports.

In some examples, to support selecting the one or more sounding reference signal sets, the control signal reception component 825 may be configured as or otherwise support a means for receiving a first reference signal indicating a first sounding reference signal set and a second reference signal indicating a second sounding reference signal set. In some examples, to support selecting the one or more sounding reference signal sets, the control signal reception component 825 may be configured as or otherwise support a means for receiving downlink control information or a configured grant including a first resource indicator associated with the first sounding reference signal set and a second resource indicator associated with the second sounding reference signal set; where the first resource indicator and the second resource indicator are sounding reference signal resource indicators.

In some examples, the first resource indicator and the second resource indicator have a same indicator rank and share a same set of demodulated reference signal ports.

In some examples, to support receiving the control signaling, the control signal reception component 825 may be configured as or otherwise support a means for receiving a control resource set associated with the control signaling, the control resource set including an indication for the UE to transmit the uplink communications to the network according to a SFN transmission scheme.

In some examples, to support receiving the control signaling, the control signal reception component 825 may be configured as or otherwise support a means for receiving a control resource set associated with the control signaling, the control resource set including an indication for the UE to transmit the uplink communications to the network according to a transmission scheme different from a SFN transmission scheme.

In some examples, the control signal reception component 825 may be configured as or otherwise support a means for receiving one or more messages indicating a first transmission configuration indicator codepoint including one or more transmission configuration indicators based on receiving the control signaling enabling the uplink communications with the network.

In some examples, to support receiving the one or more messages, the control signal reception component 825 may be configured as or otherwise support a means for receiving a medium access control-control element activating a set of multiple transmission configuration indicator codepoints configured at the UE. In some examples, to support receiving the one or more messages, the control signal reception component 825 may be configured as or otherwise support a means for receiving downlink control information including a transmission configuration indicator that indicates the first transmission configuration indicator codepoint from the set of multiple activated transmission configuration indicator codepoints.

In some examples, to support receiving the one or more messages, the control signal reception component 825 may be configured as or otherwise support a means for receiving a medium access control-control element activating a single transmission configuration indicator codepoint of a set of multiple transmission configuration indicator codepoints configured at the UE.

In some examples, the first transmission configuration indicator codepoint includes one transmission configuration indicator, and the uplink transmission component 840 may be configured as or otherwise support a means for transmitting, according to the SFN configuration, the uplink communications to the network via the first transmission and reception point, where the SFN configuration is a non-SFN transmission scheme.

In some examples, the first transmission configuration indicator codepoint includes two or more transmission configuration indicators, and the uplink SFN transmission component 830 may be configured as or otherwise support a means for transmitting, according to the SFN configuration, the uplink communications to the network via the first transmission and reception point and the second transmission and reception point, where the SFN configuration is a SFN transmission scheme.

In some examples, the first transmission configuration indicator codepoint includes two or more transmission configuration indicators, and the control signal reception component 825 may be configured as or otherwise support a means for receiving downlink control information including a transmission and reception point switching indication indicating to use a first transmission configuration indicator associated with the first transmission and reception point. In some examples, the first transmission configuration indicator codepoint includes two or more transmission configuration indicators, and the uplink transmission component 840 may be configured as or otherwise support a means for transmitting, according to the SFN configuration, the uplink communications to the network via the first transmission and reception point, where the SFN configuration includes a non-SFN transmission scheme.

In some examples, the first transmission configuration indicator codepoint includes two or more transmission configuration indicators, and the control signal reception component 825 may be configured as or otherwise support a means for receiving downlink control information including a transmission and reception point switching indication indicating to use the two or more transmission configuration indicators. In some examples, the first transmission configuration indicator codepoint includes two or more transmission configuration indicators, and the uplink SFN transmission component 830 may be configured as or otherwise support a means for transmitting, according to the SFN configuration, the uplink communications to the network via the first transmission and reception point and the second transmission and reception point, where the SFN configuration includes a SFN transmission scheme.

In some cases, the control signal reception component 825, the uplink SFN transmission component 830, the resource set selection component 835, and the uplink transmission component 840 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features the control signal reception component 825, the uplink SFN transmission component 830, the resource set selection component 835, and the uplink transmission component 840 discussed herein.

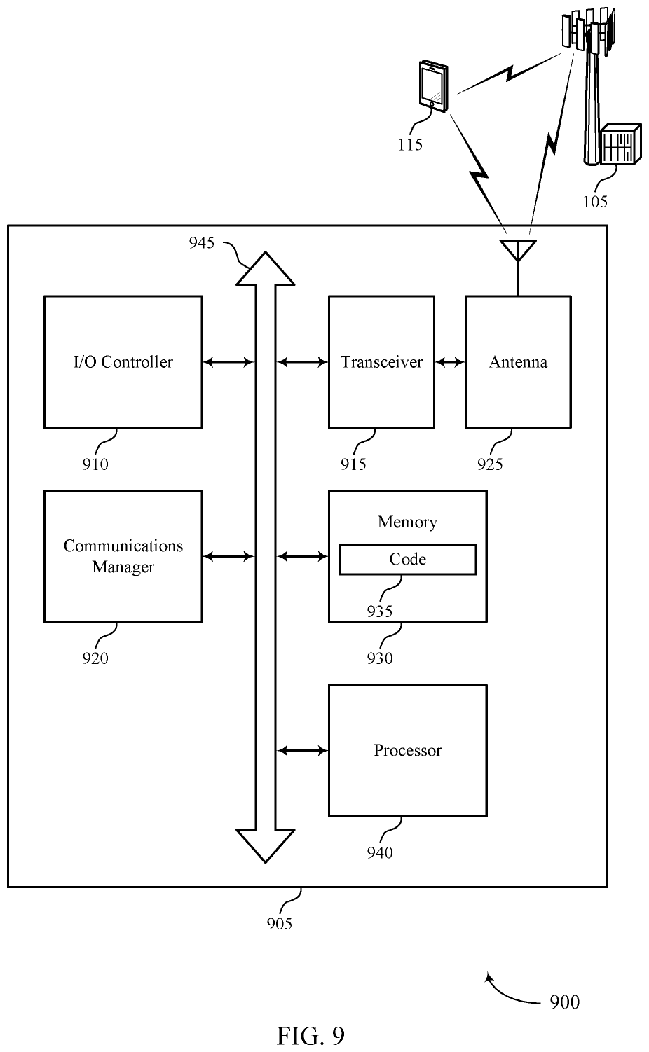

FIG. 9 shows a diagram of a system 900 including a device 905 that supports uplink SFN operation in unified TCI framework in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting uplink SFN operation in unified TCI framework). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving control signaling enabling uplink communications with a network via a first transmission and reception point using a first set of antenna elements of the UE and via a second transmission and reception point using a second set of antenna elements of the UE during a same set of time and frequency resources according to a SFN configuration. The communications manager 920 may be configured as or otherwise support a means for transmitting, according to the SFN configuration, the uplink communications to the network via the first transmission and reception point and the second transmission and reception point.

By including or configuring the communications manager 920 in accordance with examples as described herein, the device 905 may support techniques for more efficient utilization of communication resources and improved coordination between devices by configuring uplink SFN operations in a TCI framework.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of uplink SFN operation in unified TCI framework as described herein, or the processor 940 and the memory 930 may be otherwise configured to perform or support such operations.

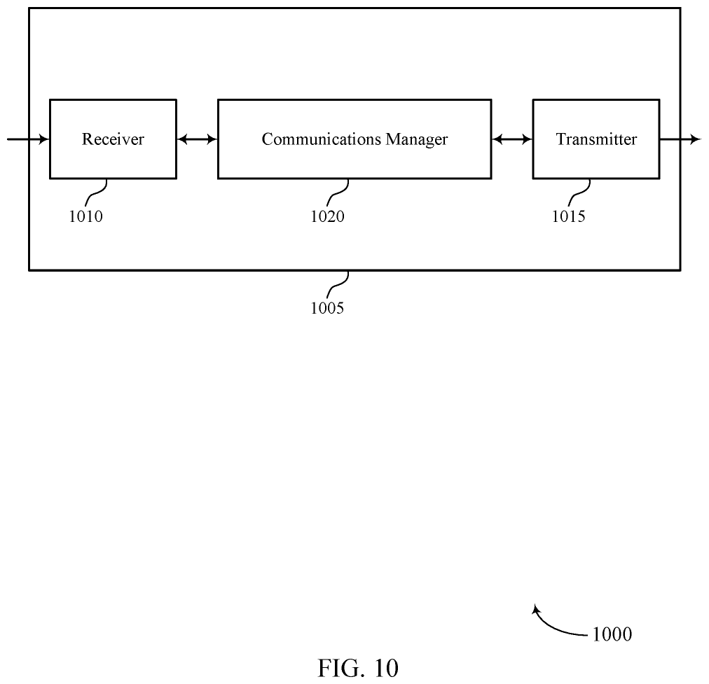

FIG. 10 shows a block diagram 1000 of a device 1005 that supports uplink SFN operation in unified TCI framework in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include one or more processors, memory coupled with the one or more processors, and instructions stored in the memory that are executable by the one or more processors to enable the one or more processors to perform the SFN features in a TCI framework as discussed herein. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of uplink SFN operation in unified TCI framework as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting, control signaling enabling a UE to perform uplink communications with a network via a first transmission and reception point using a first set of antenna elements of the UE and via a second transmission and reception point using a second set of antenna elements of the UE during a same set of time and frequency resources according to a SFN configuration. The communications manager 1020 may be configured as or otherwise support a means for receiving, according to the SFN configuration, the uplink communications to the network via the first transmission and reception point, the second transmission and reception point, or a combination thereof.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources by configuring uplink SFN operation in a TCI framework.

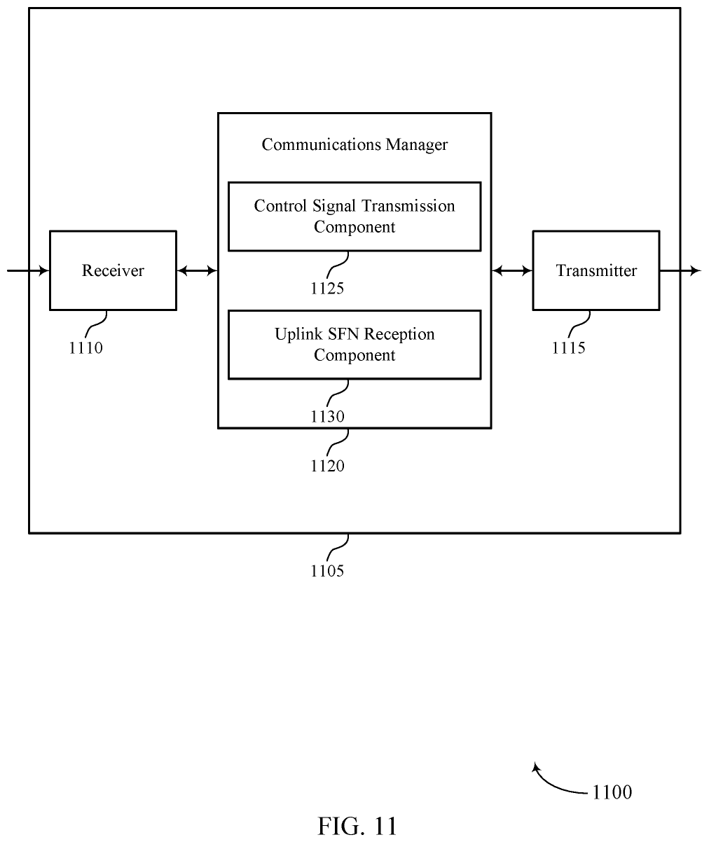

FIG. 11 shows a block diagram 1100 of a device 1105 that supports uplink SFN operation in unified TCI framework in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of uplink SFN operation in unified TCI framework as described herein. For example, the communications manager 1120 may include a control signal transmission component 1125 an uplink SFN reception component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The control signal transmission component 1125 may be configured as or otherwise support a means for transmitting, control signaling enabling a UE to perform uplink communications with a network via a first transmission and reception point using a first set of antenna elements of the UE and via a second transmission and reception point using a second set of antenna elements of the UE during a same set of time and frequency resources according to a SFN configuration. The uplink SFN reception component 1130 may be configured as or otherwise support a means for receiving, according to the SFN configuration, the uplink communications to the network via the first transmission and reception point, the second transmission and reception point, or a combination thereof.

In some cases, the control signal transmission component 1125 and the uplink SFN reception component 1130 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signal transmission component 1125 and the uplink SFN reception component 1130 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

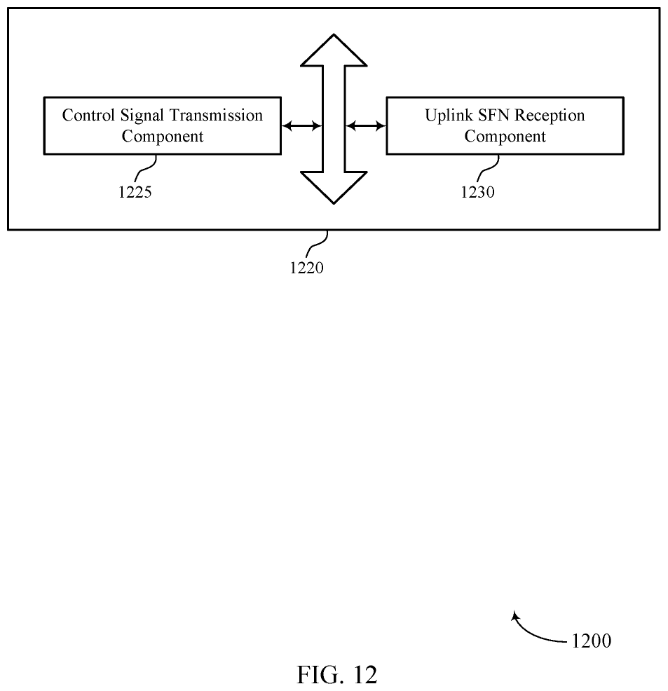

FIG. 12 shows a block diagram 1200 of a communications manager 1220 that supports uplink SFN operation in unified TCI framework in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of uplink SFN operation in unified TCI framework as described herein. For example, the communications manager 1220 may include a control signal transmission component 1225 an uplink SFN reception component 1230, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The control signal transmission component 1225 may be configured as or otherwise support a means for transmitting, control signaling enabling a UE to perform uplink communications with a network via a first transmission and reception point using a first set of antenna elements of the UE and via a second transmission and reception point using a second set of antenna elements of the UE during a same set of time and frequency resources according to a SFN configuration. The uplink SFN reception component 1230 may be configured as or otherwise support a means for receiving, according to the SFN configuration, the uplink communications to the network via the first transmission and reception point, the second transmission and reception point, or a combination thereof.

In some examples, to support transmitting the control signaling, the control signal transmission component 1225 may be configured as or otherwise support a means for transmitting a set of parameters enabling the uplink communications with the network via a physical uplink control channel or a physical uplink shared channel. In some examples, to support transmitting the control signaling, the uplink SFN reception component 1230 may be configured as or otherwise support a means for receiving, the uplink communications via the physical uplink control channel or the physical uplink shared channel in accordance with the set of parameters.

In some examples, to support transmitting the control signaling, the control signal transmission component 1225 may be configured as or otherwise support a means for transmitting a control resource set associated with control signaling, the control resource set including an indication for the UE to transmit the uplink communications to the network according to a SFN transmission scheme.

In some examples, to support transmitting the control signaling, the control signal transmission component 1225 may be configured as or otherwise support a means for transmitting a control resource set associated with the control signaling, the control resource set including an indication for the UE to transmit the uplink communications to the network according to a transmission scheme different from a SFN transmission scheme.

In some examples, the control signal transmission component 1225 may be configured as or otherwise support a means for transmitting one or more messages indicating a first transmission configuration indicator codepoint including one or more transmission configuration indicators based on receiving the control signaling enabling the uplink communications with the network.

In some cases, the control signal transmission component 1225 and the uplink SFN reception component 1230 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signal transmission component 1225 and the uplink SFN reception component 1230 discussed herein.

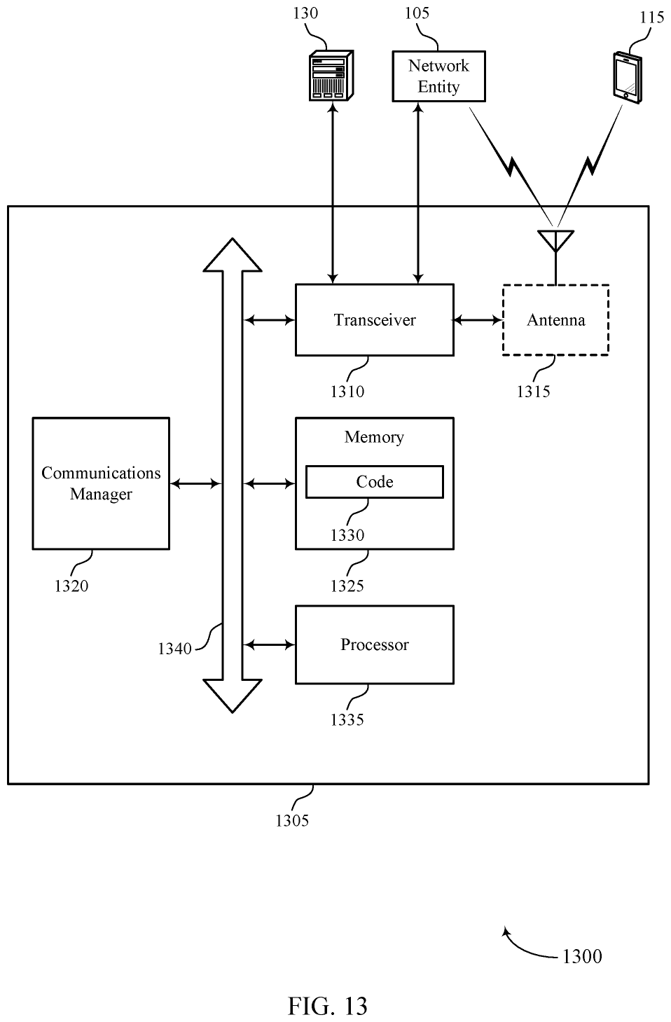

FIG. 13 shows a diagram of a system 1300 including a device 1305 that supports uplink SFN operation in unified TCI framework in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting uplink SFN operation in unified TCI framework). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting, control signaling enabling a UE to perform uplink communications with a network via a first transmission and reception point using a first set of antenna elements of the UE and via a second transmission and reception point using a second set of antenna elements of the UE during a same set of time and frequency resources according to a SFN configuration. The communications manager 1320 may be configured as or otherwise support a means for receiving, according to the SFN configuration, the uplink communications to the network via the first transmission and reception point, the second transmission and reception point, or a combination thereof.

By including or configuring the communications manager 1320 in accordance with examples as described herein, the device 1305 may support techniques for may support techniques for more efficient utilization of communication resources and improved coordination between devices by configuring uplink SFN operations in a TCI framework.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of uplink SFN operation in unified TCI framework as described herein, or the processor 1335 and the memory 1325 may be otherwise configured to perform or support such operations.

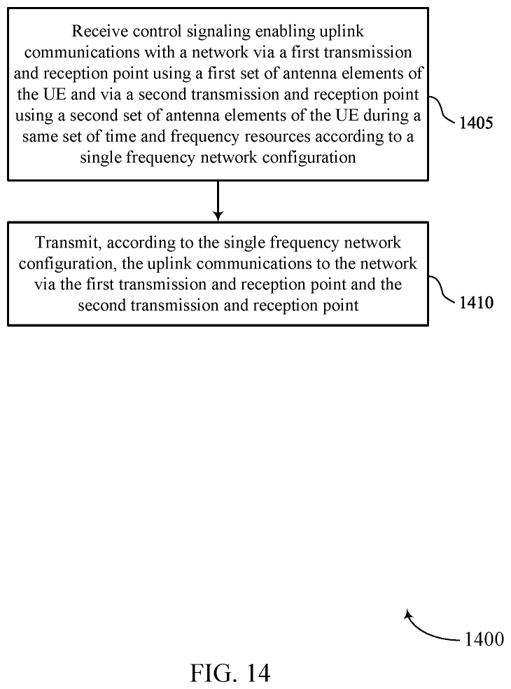

FIG. 14 shows a flowchart illustrating a method 1400 that supports uplink SFN operation in unified TCI framework in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control signaling enabling uplink communications with a network via a first transmission and reception point using a first set of antenna elements of the UE and via a second transmission and reception point using a second set of antenna elements of the UE during a same set of time and frequency resources according to a SFN configuration. The operations of 1405 may be performed in accordance with examples as disclosed herein. In some examples, aspects of the operations of 1405 may be performed by a control signal reception component 825 as described with reference to FIG. 8.

At 1410, the method may include transmitting, according to the SFN configuration, the uplink communications to the network via the first transmission and reception point and the second transmission and reception point. The operations of 1410 may be performed in accordance with examples as disclosed herein. In some examples, aspects of the operations of 1410 may be performed by an uplink SFN transmission component 830 as described with reference to FIG. 8.

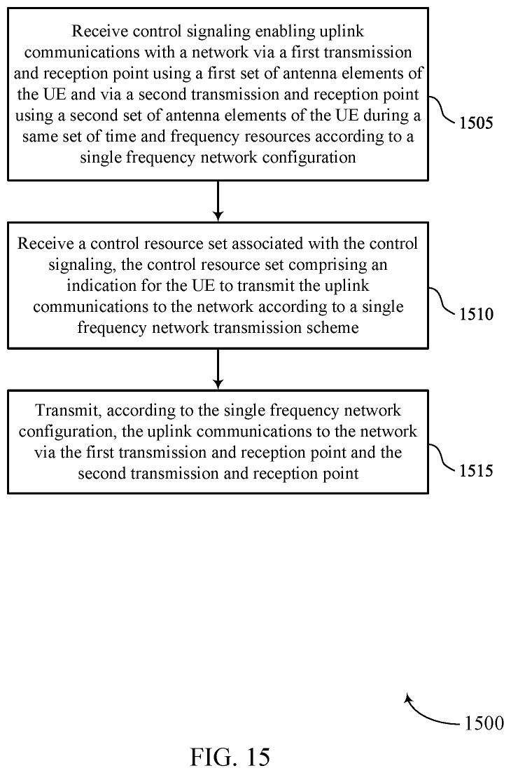

FIG. 15 shows a flowchart illustrating a method 1500 that supports uplink SFN operation in unified TCI framework in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving control signaling enabling uplink communications with a network via a first transmission and reception point using a first set of antenna elements of the UE and via a second transmission and reception point using a second set of antenna elements of the UE during a same set of time and frequency resources according to a SFN configuration. The operations of 1505 may be performed in accordance with examples as disclosed herein. In some examples, aspects of the operations of 1505 may be performed by a control signal reception component 825 as described with reference to FIG. 8.

At 1510, the method may include receiving a control resource set associated with the control signaling, the control resource set including an indication for the UE to transmit the uplink communications to the network according to a SFN transmission scheme. The operations of 1510 may be performed in accordance with examples as disclosed herein. In some examples, aspects of the operations of 1510 may be performed by a control signal reception component 825 as described with reference to FIG. 8.

At 1515, the method may include transmitting, according to the SFN configuration, the uplink communications to the network via the first transmission and reception point and the second transmission and reception point. The operations of 1515 may be performed in accordance with examples as disclosed herein. In some examples, aspects of the operations of 1515 may be performed by an uplink SFN transmission component 830 as described with reference to FIG. 8.

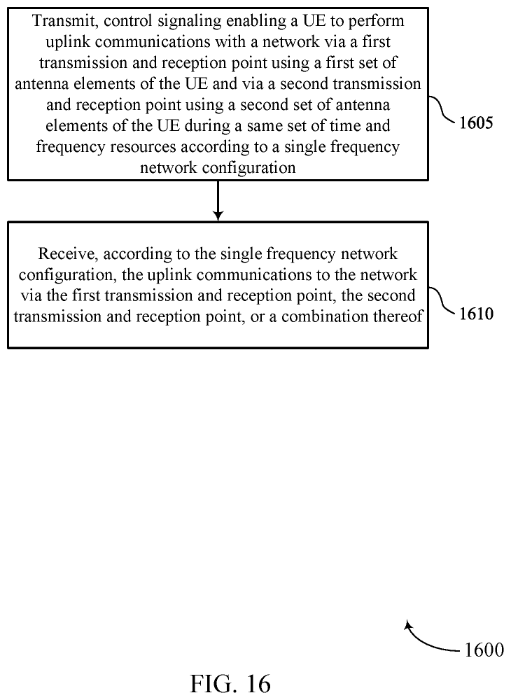

FIG. 16 shows a flowchart illustrating a method 1600 that supports uplink SFN operation in unified TCI framework in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, control signaling enabling a UE to perform uplink communications with a network via a first transmission and reception point using a first set of antenna elements of the UE and via a second transmission and reception point using a second set of antenna elements of the UE during a same set of time and frequency resources according to a SFN configuration. The operations of 1605 may be performed in accordance with examples as disclosed herein. In some examples, aspects of the operations of 1605 may be performed by a control signal transmission component 1225 as described with reference to FIG. 12.

At 1610, the method may include receiving, according to the SFN configuration, the uplink communications to the network via the first transmission and reception point, the second transmission and reception point, or a combination thereof. The operations of 1610 may be performed in accordance with examples as disclosed herein. In some examples, aspects of the operations of 1610 may be performed by an uplink SFN reception component 1230 as described with reference to FIG. 12.

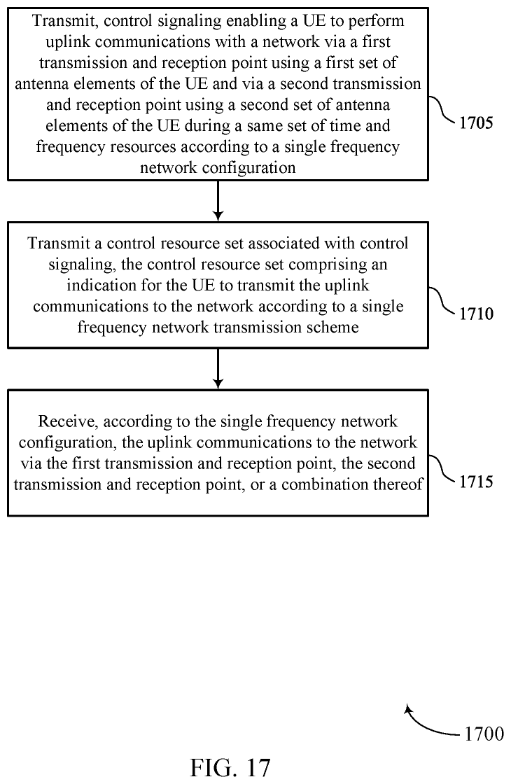

FIG. 17 shows a flowchart illustrating a method 1700 that supports uplink SFN operation in unified TCI framework in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, control signaling enabling a UE to perform uplink communications with a network via a first transmission and reception point using a first set of antenna elements of the UE and via a second transmission and reception point using a second set of antenna elements of the UE during a same set of time and frequency resources according to a SFN configuration. The operations of 1705 may be performed in accordance with examples as disclosed herein. In some examples, aspects of the operations of 1705 may be performed by a control signal transmission component 1225 as described with reference to FIG. 12.

At 1710, the method may include transmitting a control resource set associated with control signaling, the control resource set including an indication for the UE to transmit the uplink communications to the network according to a SFN transmission scheme. The operations of 1710 may be performed in accordance with examples as disclosed herein. In some examples, aspects of the operations of 1710 may be performed by a control signal transmission component 1225 as described with reference to FIG. 12.

At 1715, the method may include receiving, according to the SFN configuration, the uplink communications to the network via the first transmission and reception point, the second transmission and reception point, or a combination thereof. The operations of 1715 may be performed in accordance with examples as disclosed herein. In some examples, aspects of the operations of 1715 may be performed by an uplink SFN reception component 1230 as described with reference to FIG. 12.

The following provides an overview of aspects of the present disclosure:

Aspect 1: A method for wireless communications at a UE, comprising: receiving control signaling enabling uplink communications with a network via a first TRP using a first set of antenna elements of the UE and via a second TRP using a second set of antenna elements of the UE during a same set of time and frequency resources according to a SFN configuration; and transmitting, according to the SFN configuration, the uplink communications to the network via the first TRP and the second TRP.

Aspect 2: The method of aspect 1, wherein receiving the control signaling further comprises: receiving a set of parameters enabling the uplink communications with the network via a PUCCH or a PUSCH; and transmitting, the uplink communications to the network via the PUCCH or the PUSCH in accordance with the set of parameters.

Aspect 3: The method of any of aspects 1 through 2, further comprising: selecting one or more SRS sets based at least in part on receiving the control signaling enabling the uplink communications with the network according to the SFN configuration.

Aspect 4: The method of aspect 3, wherein selecting the one or more SRS sets comprises: selecting a first SRS set and a second SRS set configured at the UE; and receiving DCI or a configured grant comprising a first resource indicator associated with the first SRS set and a second resource indicator associated with the second SRS set: wherein the first resource indicator and the second resource indicator are SRIs, TPMIs, or a combination thereof.

Aspect 5: The method of aspect 4, wherein the first resource indicator and the second resource indicator have a same indicator rank and share a same set of demodulated reference signal ports.

Aspect 6: The method of any of aspects 3 through 5, wherein selecting the one or more SRS sets further comprises: receiving a first reference signal indicating a first SRS set and a second reference signal indicating a second SRS set; and receiving DCI or a configured grant comprising a first resource indicator associated with the first SRS set and a second resource indicator associated with the second SRS set: wherein the first resource indicator and the second resource indicator are SRIs.

Aspect 7: The method of aspect 6, wherein the first resource indicator and the second resource indicator have a same indicator rank and share a same set of demodulated reference signal ports.

Aspect 8: The method of any of aspects 1 through 7, wherein receiving the control signaling further comprises: receiving a CORESET associated with the control signaling, the CORESET comprising an indication for the UE to transmit the uplink communications to the network according to a SFN transmission scheme.

Aspect 9: The method of any of aspects 1 through 8, wherein receiving the control signaling further comprises: receiving a CORESET associated with the control signaling, the CORESET comprising an indication for the UE to transmit the uplink communications to the network according to a transmission scheme different from a SFN transmission scheme.

Aspect 10: The method of any of aspects 1 through 9, further comprising: receiving one or more messages indicating a first TCI codepoint comprising one or more TCIs based at least in part on receiving the control signaling enabling the uplink communications with the network.

Aspect 11: The method of aspect 10, wherein receiving the one or more messages further comprises: receiving a MAC-CE activating a plurality of TCI codepoints configured at the UE; and receiving DCI comprising a TCI that indicates the first TCI codepoint from the plurality of activated TCI codepoints.

Aspect 12: The method of any of aspects 10 through 11, wherein receiving the one or more messages further comprises: receiving a MAC-CE activating a single TCI codepoint of a plurality of TCI codepoints configured at the UE.

Aspect 13: The method of any of aspects 10 through 12, wherein the first TCI codepoint comprises one TCI, the method further comprising: transmitting, according to the SFN configuration, the uplink communications to the network via the first TRP, wherein the SFN configuration is a non-SFN transmission scheme.

Aspect 14: The method of any of aspects 10 through 13, wherein the first TCI codepoint comprises two or more TCIs, the method further comprising: transmitting, according to the SFN configuration, the uplink communications to the network via the first TRP and the second TRP, wherein the SFN configuration is a SFN transmission scheme.

Aspect 15: The method of any of aspects 10 through 14, wherein the first TCI codepoint comprises two or more TCIs, the method further comprising: receiving DCI comprising a TRP switching indication indicating to use a first TCI associated with the first TRP; and transmitting, according to the SFN configuration, the uplink communications to the network via the first TRP, wherein the SFN configuration comprises a non-SFN transmission scheme.

Aspect 16: The method of any of aspects 10 through 15, wherein the first TCI codepoint comprises two or more TCIs, the method further comprising: receiving DCI comprising a TRP switching indication indicating to use the two or more TCIs; and transmitting, according to the SFN configuration, the uplink communications to the network via the first TRP and the second TRP, wherein the SFN configuration comprises a SFN transmission scheme.

Aspect 17: A method for wireless communications at a network entity, comprising: transmitting, control signaling enabling a UE to perform uplink communications with a network via a first TRP using a first set of antenna elements of the UE and via a second TRP using a second set of antenna elements of the UE during a same set of time and frequency resources according to a SFN configuration; and receiving, according to the SFN configuration, the uplink communications to the network via the first TRP, the second TRP, or a combination thereof.

Aspect 18: The method of aspect 17, wherein transmitting the control signaling further comprises: transmitting a set of parameters enabling the uplink communications with the network via a PUCCH or a PUSCH; and receiving, the uplink communications via the PUCCH or the PUSCH in accordance with the set of parameters.

Aspect 19: The method of any of aspects 17 through 18, wherein transmitting the control signaling further comprises: transmitting a CORESET associated with control signaling, the CORESET comprising an indication for the UE to transmit the uplink communications to the network according to a SFN transmission scheme.

Aspect 20: The method of any of aspects 17 through 19, wherein transmitting the control signaling further comprises: transmitting a CORESET associated with the control signaling, the CORESET comprising an indication for the UE to transmit the uplink communications to the network according to a transmission scheme different from a SFN transmission scheme.

Aspect 21: The method of any of aspects 17 through 20, further comprising: transmitting one or more messages indicating a first TCI codepoint comprising one or more TCIs based at least in part on receiving the control signaling enabling the uplink communications with the network.

Aspect 22: An apparatus for wireless communications at a UE, comprising a processor: memory coupled with the processor; and instructions stored in the memory and executable by the processor to cause the apparatus to perform a method of any of aspects 1 through 16.

Aspect 23: An apparatus for wireless communications at a UE, comprising at least one means for performing a method of any of aspects 1 through 16.

Aspect 24: A non-transitory computer-readable medium storing code for wireless communications at a UE, the code comprising instructions executable by a processor to perform a method of any of aspects 1 through 16.

Aspect 25: An apparatus for wireless communications at a network entity, comprising a processor: memory coupled with the processor; and instructions stored in the memory and executable by the processor to cause the apparatus to perform a method of any of aspects 17 through 21.

Aspect 26: An apparatus for wireless communications at a network entity, comprising at least one means for performing a method of any of aspects 17 through 21.

Aspect 27: A non-transitory computer-readable medium storing code for wireless communications at a network entity, the code comprising instructions executable by a processor to perform a method of any of aspects 17 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive control signaling enabling uplink communications with a network via a first transmission and reception point using a first set of antenna elements of the UE and via a second transmission and reception point using a second set of antenna elements of the UE during a same set of time and frequency resources according to a single frequency network configuration; and
transmit, according to the single frequency network configuration, the uplink communications to the network via the first transmission and reception point and the second transmission and reception point.

2. The apparatus of claim 1, wherein the instructions to receive the control signaling are further executable by the processor to cause the apparatus to:
receive a set of parameters enabling the uplink communications with the network via a physical uplink control channel or a physical uplink shared channel; and
transmit, the uplink communications to the network via the physical uplink control channel or the physical uplink shared channel in accordance with the set of parameters.

3. The apparatus of claim 1, wherein the instructions are further executable by the processor to cause the apparatus to:
select one or more sounding reference signal sets based at least in part on receiving the control signaling enabling the uplink communications with the network according to the single frequency network configuration.

4. The apparatus of claim 3, wherein the instructions to select the one or more sounding reference signal sets are executable by the processor to cause the apparatus to:
select a first sounding reference signal set and a second sounding reference signal set configured at the UE; and
receive downlink control information or a configured grant comprising a first resource indicator associated with the first sounding reference signal set and a second resource indicator associated with the second sounding reference signal set; wherein the first resource indicator and the second resource indicator are sounding reference signal resource indicators, transmit precoding matrix indices, or a combination thereof.

5. The apparatus of claim 4, wherein the first resource indicator and the second resource indicator have a same indicator rank and share a same set of demodulated reference signal ports.

6. The apparatus of claim 3, wherein the instructions to select the one or more sounding reference signal sets are further executable by the processor to cause the apparatus to:
receive a first reference signal indicating a first sounding reference signal set and a second reference signal indicating a second sounding reference signal set; and
receive downlink control information or a configured grant comprising a first resource indicator associated with the first sounding reference signal set and a second resource indicator associated with the second sounding reference signal set;
wherein the first resource indicator and the second resource indicator are sounding reference signal resource indicators.

7. The apparatus of claim 6, wherein the first resource indicator and the second resource indicator have a same indicator rank and share a same set of demodulated reference signal ports.

8. The apparatus of claim 1, wherein the instructions to receive the control signaling are further executable by the processor to cause the apparatus to:
receive a control resource set associated with the control signaling, the control resource set comprising an indication for the UE to transmit the uplink communications to the network according to a single frequency network transmission scheme.

9. The apparatus of claim 1, wherein the instructions to receive the control signaling are further executable by the processor to cause the apparatus to:
receive a control resource set associated with the control signaling, the control resource set comprising an indication for the UE to transmit the uplink communications to the network according to a transmission scheme different from a single frequency network transmission scheme.

10. The apparatus of claim 1, wherein the instructions are further executable by the processor to cause the apparatus to:
receive one or more messages indicating a first transmission configuration indicator codepoint comprising one or more transmission configuration indicators based at least in part on receiving the control signaling enabling the uplink communications with the network.

11. The apparatus of claim 10, wherein the instructions to receive the one or more messages are further executable by the processor to cause the apparatus to:
receive a medium access control-control element activating a plurality of transmission configuration indicator codepoints configured at the UE; and
receive downlink control information comprising a transmission configuration indicator that indicates the first transmission configuration indicator codepoint from the plurality of activated transmission configuration indicator codepoints.

12. The apparatus of claim 10, wherein the instructions to receive the one or more messages are further executable by the processor to cause the apparatus to:
receive a medium access control-control element activating a single transmission configuration indicator codepoint of a plurality of transmission configuration indicator codepoints configured at the UE.

13. The apparatus of claim 10, wherein the first transmission configuration indicator codepoint comprises one transmission configuration indicator, and the instructions are further executable by the processor to cause the apparatus to:
transmit, according to the single frequency network configuration, the uplink communications to the network via the first transmission and reception point, wherein the single frequency network configuration is a non-single frequency network transmission scheme.

14. The apparatus of claim 10, wherein the first transmission configuration indicator codepoint comprises two or more transmission configuration indicators, and the instructions are further executable by the processor to cause the apparatus to:
transmit, according to the single frequency network configuration, the uplink communications to the network via the first transmission and reception point and the second transmission and reception point, wherein the single frequency network configuration is a single frequency network transmission scheme.

15. The apparatus of claim 10, wherein the first transmission configuration indicator codepoint comprises two or more transmission configuration indicators, and the instructions are further executable by the processor to cause the apparatus to:
receive downlink control information comprising a transmission and reception point switching indication indicating to use a first transmission configuration indicator associated with the first transmission and reception point; and
transmit, according to the single frequency network configuration, the uplink communications to the network via the first transmission and reception point, wherein the single frequency network configuration comprises a non-single frequency network transmission scheme.

16. The apparatus of claim 10, wherein the first transmission configuration indicator codepoint comprises two or more transmission configuration indicators, and the instructions are further executable by the processor to cause the apparatus to:
receive downlink control information comprising a transmission and reception point switching indication indicating to use the two or more transmission configuration indicators; and
transmit, according to the single frequency network configuration, the uplink communications to the network via the first transmission and reception point and the second transmission and reception point, wherein the single frequency network configuration comprises a single frequency network transmission scheme.

17. An apparatus for wireless communications at a network entity, comprising:
a processor;
memory coupled with the processor; and
instructions stored in the memory and executable by the processor to cause the apparatus to:
transmit, control signaling enabling a user equipment (UE) to perform uplink communications with a network via a first transmission and reception point using a first set of antenna elements of the UE and via a second transmission and reception point using a second set of antenna elements of the UE during a same set of time and frequency resources according to a single frequency network configuration; and
receive, according to the single frequency network configuration, the uplink communications to the network via the first transmission and reception point, the second transmission and reception point, or a combination thereof.

18. The apparatus of claim 17, wherein the instructions to transmit the control signaling are further executable by the processor to cause the apparatus to:
transmit a set of parameters enabling the uplink communications with the network via a physical uplink control channel or a physical uplink shared channel; and
receive, the uplink communications via the physical uplink control channel or the physical uplink shared channel in accordance with the set of parameters.

19. The apparatus of claim 17, wherein the instructions to transmit the control signaling are further executable by the processor to cause the apparatus to:
transmit a control resource set associated with control signaling, the control resource set comprising an indication for the UE to transmit the uplink communications to the network according to a single frequency network transmission scheme.

20. The apparatus of claim 17, wherein the instructions to transmit the control signaling are further executable by the processor to cause the apparatus to:
transmit a control resource set associated with the control signaling, the control resource set comprising an indication for the UE to transmit the uplink communications to the network according to a transmission scheme different from a single frequency network transmission scheme.

21. The apparatus of claim 17, wherein the instructions are further executable by the processor to cause the apparatus to:
transmit one or more messages indicating a first transmission configuration indicator codepoint comprising one or more transmission configuration indicators based at least in part on receiving the control signaling enabling the uplink communications with the network.

22. A method for wireless communications at a user equipment (UE), comprising:
receiving control signaling enabling uplink communications with a network via a first transmission and reception point using a first set of antenna elements of the UE and via a second transmission and reception point using a second set of antenna elements of the UE during a same set of time and frequency resources according to a single frequency network configuration; and
transmitting, according to the single frequency network configuration, the uplink communications to the network via the first transmission and reception point and the second transmission and reception point.

23. The method of claim 22, wherein receiving the control signaling further comprises:
receiving a set of parameters enabling the uplink communications with the network via a physical uplink control channel or a physical uplink shared channel; and
transmitting, the uplink communications to the network via the physical uplink control channel or the physical uplink shared channel in accordance with the set of parameters.

24. The method of claim 22, further comprising:
selecting one or more sounding reference signal sets based at least in part on receiving the control signaling enabling the uplink communications with the network according to the single frequency network configuration.

25. The method of claim 24, wherein selecting the one or more sounding reference signal sets comprises:
selecting a first sounding reference signal set and a second sounding reference signal set configured at the UE; and
receiving downlink control information or a configured grant comprising a first resource indicator associated with the first sounding reference signal set and a second resource indicator associated with the second sounding reference signal set;
wherein the first resource indicator and the second resource indicator are sounding reference signal resource indicators, transmit precoding matrix indices, or a combination thereof.

26. The method of claim 25, wherein the first resource indicator and the second resource indicator have a same indicator rank and share a same set of demodulated reference signal ports.

27. The method of claim 24, wherein selecting the one or more sounding reference signal sets further comprises:
receiving a first reference signal indicating a first sounding reference signal set and a second reference signal indicating a second sounding reference signal set; and
receiving downlink control information or a configured grant comprising a first resource indicator associated with the first sounding reference signal set and a second resource indicator associated with the second sounding reference signal set; wherein the first resource indicator and the second resource indicator are sounding reference signal resource indicators.

28. The method of claim 27, wherein the first resource indicator and the second resource indicator have a same indicator rank and share a same set of demodulated reference signal ports.

29. A method for wireless communications at a network entity, comprising:
transmitting, control signaling enabling a user equipment (UE) to perform uplink communications with a network via a first transmission and reception point using a first set of antenna elements of the UE and via a second transmission and reception point using a second set of antenna elements of the UE during a same set of time and frequency resources according to a single frequency network configuration; and
receiving, according to the single frequency network configuration, the uplink communications to the network via the first transmission and reception point, the second transmission and reception point, or a combination thereof.

30. The method of claim 29, wherein transmitting the control signaling further comprises:
transmitting a set of parameters enabling the uplink communications with the network via a physical uplink control channel or a physical uplink shared channel; and
receiving, the uplink communications via the physical uplink control channel or the physical uplink shared channel in accordance with the set of parameters.
